(19) United States
(12) Patent Application Publication
(10) Pub. No.: US 2019/0283220 A1
(43) Pub. Date: Sep. 19, 2019

(54) GREASE-FITTING INSTALLATION TOOL AND METHOD

(71) Applicant: Roy Joseph Blanchette, Prince George (CA)

(72) Inventor: Roy Joseph Blanchette, Prince George (CA)

(21) Appl. No.: 15/923,589

(22) Filed: Mar. 16, 2018

(51) Int. Cl. B25B 13/50; B25B 13/48; B25B 23/10; B25B 23/12

(52) U.S. Cl. CPC B25B 13/50; B25B 23/12; B25B 23/108; B25B 13/481

(57) ABSTRACT

A grease-fitting installation tool is disclosed herein. The grease-fitting installation tool may include a hand-tool useful for installing and uninstalling a grease-fitting that has a hexagonal-collar, a threaded-shank, and a nipple, i.e., a Zerk fitting. The hand-tool may have a first tool-head and a second tool-head, each able to receive and manipulate a grease-fitting. The first and second tool-heads may be attached end to end, being joined in the center of a hand-tool by a couple. The couple may have a wrench interface allowing the hand-tool to be engaged by a wrench or other tool. Each tool-head may include a hollow-socket having a socket-aperture and six internal contact-surfaces which are hexagonally arranged. The tool-head may also include a deformable, cylindrical gripping member disposed within the hollow-socket for retaining the grease-fitting when the grease-fitting is inserted into the gripping member.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of hand-tools of existing art and more specifically relates to a mechanical drive tool.

### RELATED ART

Since 1929, a variant of grease-fittings known as a ‘Zerk’ or “Alemite” fitting has been in widespread use as an effective and nearly universal means of servicing greased bearings while preventing loss or contamination of the grease contained by the fitting. These grease-fittings are serviceable by a pressurized greasing gun which attaches to a nipple on the top of the fitting. The grease fitting is usually threaded into a mechanical component containing grease by a tapered thread. Most commonly, these fittings include a hexagonal-collar that may be engaged by a hand tool so that they may be removed by rotating the fitting within the mechanical component.

Unfortunately, by nature of the complexity of many machines utilizing grease-fittings, it may be difficult to obtain ample access and room to install or remove the fitting. In addition, due to the small size of the fittings, they may often be dropped and lost or damaged once removed from the machine, or while attempting to install. The inevitable presence of oil or grease may exacerbate this problem. A suitable solution is desired.

U.S. Pat. No. 1,867,372 to John J. McGuckin relates to a grease-fitting tool. The described grease-fitting tool includes a tool for manipulating grease-fittings such as are in common use under the name of the Zerk or the Alemite fittings for automobiles and similar machines. The wrench element is provided with suitable means for turning it by hand, such as a crossbar passed through and firmly held in the body of the tool. It is convenient to finish one end of such cross bar so as to form an extractor, which maybe driven into the bore of a broken fitting to back it out of its seat, and to finish the other end with a tap which may be used to clear the thread in the seat for the fitting.

### SUMMARY OF THE INVENTION

In view of the foregoing disadvantages inherent in the known hand-tool art, the present disclosure provides a novel grease-fitting installation tool and method. The general purpose of the present disclosure, which will be described subsequently in greater detail, is to provide an efficient and effective grease-fitting installation tool and method.

A grease-fitting installation tool is disclosed herein. The grease-fitting installation tool may include a hand-tool useful for installing and uninstalling a grease-fitting that has a hexagonal-collar, a threaded-shank, and a nipple, i.e., a Zerk fitting. The hand-tool may have a first tool-head and a second tool-head, each able to receive and manipulate a grease-fitting. The first and second tool-heads may be attached end to end, being joined in the center of a hand-tool by a couple. The couple may have a wrench interface allowing the hand-tool to be engaged by a wrench or other tool. Each tool-head may include a hollow-socket having a socket-aperture and six internal contact-surfaces which are hexagonally arranged. The six internal contact-surfaces may be able to releasably engage the hexagonal-collar of the grease-fitting such that the grease-fitting may not rotate within the hollow-socket while in engagement with the six internal contact-surfaces. The tool-head may also include a deformable, cylindrical gripping member disposed within the hollow-socket. The gripping member may have an interior diameter smaller than an exterior diameter of the nipple of the grease-fitting. This may enable the gripping member to deform around the nipple of the grease-fitting when the grease-fitting is inserted into the gripping member.

According to another embodiment, a method of installing a grease-fitting is also disclosed herein. The method of installing a grease-fitting may include firstly, providing the described grease-fitting installation tool; secondly, inserting the grease-fitting into the hollow-socket, such that the hexagonal-collar of the grease fitting is in engagement with the six internal contact-surfaces (or more or less) of the hollow-socket; thirdly, placing the threaded-shank of the grease-fitting against a grease-fitting receptacle; fourthly, rotating the hand-tool clockwise to advance the threaded-shank of the grease-fitting within the grease-receptacle; fifthly, removing the hand-tool from the grease fitting; and sixthly and optionally, rotating the hand-tool counter-clockwise to withdraw the threaded-shank of the grease-fitting from within the grease-fitting receptacle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a grease-fitting installation tool and method, constructed and operative according to the teachings of the present disclosure.

FIG. 1 is a perspective view of the grease-fitting installation tool during an ‘in-use’ condition, according to an embodiment of the disclosure.

FIG. 2 is a front perspective view of the grease-fitting installation tool of FIG. 1, according to an embodiment of the present disclosure.

FIG. 3 is a cutaway view of the tool-head of the grease-fitting installation tool of FIG. 1, according to an embodiment of the present disclosure.

FIG. 4 is a cutaway view of the grease-fitting installation tool of FIG. 1, according to an embodiment of the present disclosure.

FIG. 5 is a flow diagram illustrating a method of use for installation of a grease-fitting, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a hand-tool and more particularly to a grease-fitting installation tool and method as used to improve the installation of a grease-fitting.

Generally, the grease-fitting installation tool may include a hand-tool allowing a user to easily manipulate a grease fitting, especially a Zerk type (or other) fitting which is threaded into a mechanical component such as a U-Joint or ball joint. The hand-tool utilizes at least one socket with mechanisms for engaging and retaining such a grease fitting. Preferably, the hand-tool includes two tool-heads joined end-to-end with a wrench-engaging member in between the two tool-heads. The wrench-engaging member may have six hexagonally arranged faces or two opposing sides for a wrench or other tool to engage for rotating the hand-tool. In use, the hand-tool may engage the grease-fitting, while a wrench is also used to turn the wrench-engaging member, thereby imparting more torque to the hand-tool than a user's hand is able to alone. The two tool-heads are preferably of differing sizes so that two tools may be obtained in one item. For example, the first tool-head may include a seven-sixteenths inch socket, and the second tool-head may include a five-sixteenths inch socket. In another embodiment, the hand-tool may have a handle, a single tool-head, and a shaft connecting the handle to the tool-head on the same axis that the grease fitting is threaded on. In either embodiment, the tool-head contains a six-face socket which is sized to accommodate one of several common sizes of Zerk fittings.

The socket includes a deformable, tubular insert which is concentric to the socket and only occupies a portion of the length of the socket. The interior of the tubular insert may be sized to accommodate the nipple of the grease fitting and may be slightly smaller in diameter than the outside of the nipple, so that when the tubular insert engages the nipple it deforms and retains the nipple both by friction and by mechanical retention. The tubular insert preferably engages only the nipple, allowing the six-faced (or other number of sides) portion of the grease fitting to be in contact with the socket, and leaving the threaded portion of the grease fitting exposed outside the tool. In some embodiments, the tubular insert may be complemented or replaced by a magnetic insert capable of retaining a ferrous grease fitting in direct contact with the magnet. Two common sizes of sockets used may be five-sixteenths and seven-sixteenths of an inch. Other Imperial or metric sizes may be used, especially if they correspond to a commercially available size of grease fitting.

In use during an installation process, the hand-tool may be used to retain a grease fitting within the tool-head by the mechanisms described. A user may grasp the tool to place and orient the grease fitting relative to a mechanical component into which the grease fitting is to be installed, especially a threaded aperture able to receive the threaded portion of the grease fitting. Once oriented correctly, the user may rotate the hand-tool, preferably clockwise, to thread the grease fitting into the mechanical component. Alternatively, a wrench may be used to turn the hand-tool. The hand-tool may have enough mechanical strength to convey sufficient torque from the user or the wrench to the grease fitting for permanent installation and sealing. The hand-tool is advantageous in this instance because the grease-fitting is retained within the hand-tool throughout orientation and installation, allowing easy installation of a component which is often too small to be easily manipulated by a user's hand, especially in difficult-to-reach and low visibility conditions.

In use during a removal process, the hand-tool may be used to engage a grease fitting already installed in a mechanical component, and may be turned, preferably counter-clockwise, to disengage the threaded portion of the grease fitting from the mechanical component. The hand-tool is advantageous in this instance because the grease-fitting is retained within the hand-tool and is not dropped or lost when removed from the mechanical component.

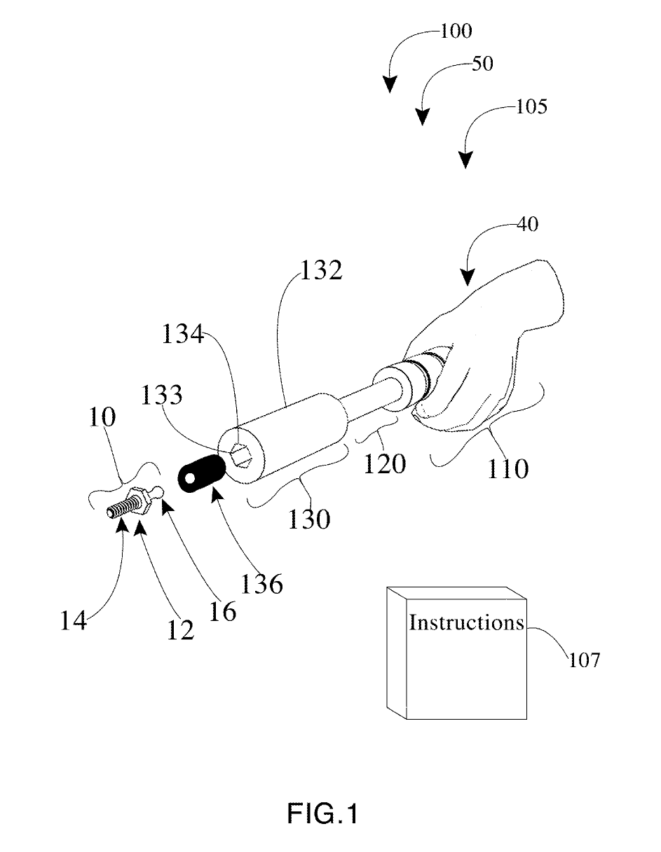

Referring now more specifically to the drawings by numerals of reference, there is shown in FIGS. 1-4, various views of a hand-tool 100.

FIG. 1 shows a hand-tool 100 during an ‘in-use’ condition 50, according to an embodiment of the present disclosure. Here, hand-tool 100 may be beneficial for use by a user 40 to install a grease-fitting. As illustrated, hand-tool 100 may include first-tool head 130, second-tool head 131, and tool-head couple 120. Hand-tool 100 may be useful for installing or uninstalling grease-fitting 10, grease-fitting 10 having hexagonal-collar 12, threaded-shank 14, and nipple 16. Hand-tool 100 may include handle 110, handle 110 being structured and arranged to be grasped by user 40. First-tool head 130 and second-tool head 131 each may include hollow-socket 132 and gripping-member 136. Tool-interface 124 may be configured to engage with wrench 90, and may include couple-axis 122 and tool-interface 124. Tool-head couple 120 may join first-tool head 130 to second-tool head 131. Tool-interface 124 may include six consecutively positioned faces 126 able to be engaged by wrench 90, each of six consecutively positioned faces 126 being angled sixty degrees from an adjacent one of the six consecutively positioned faces 126 to join circumferentially about couple-axis 122, six consecutively positioned faces 126 being radially arrayed about couple-axis 122. Tool-interface 124 may alternatively include pair of substantially flat faces 128 able to be engaged by wrench 90, pair of substantially flat faces 128 being diametrically opposed across couple-axis 122. First-tool head 130 and second-tool head 131 are each positioned concentrically to couple-axis 122, such that first-tool head 130 and alternatively second-tool head 131 may engage and turn grease-fitting 10 while rotating on couple-axis 122.

Hollow-socket 132 may have socket-aperture 133 and six (or the like) internal contact-surfaces 134. Six internal contact-surfaces 134 may be hexagonally (or other) arranged, and may be able to releasably engage hexagonal-collar 12 of grease-fitting 10 such that grease-fitting 10 may not rotate relative to hollow-socket 132 while in engagement with six internal contact-surfaces 134. Gripping member 136 may be deformable and tubularly shaped, and may be disposed concentrically within hollow-socket 132, and may be internally smaller than nipple 16 of grease-fitting 10, such that gripping member 136 deforms around nipple 16 of grease-fitting 10 when grease-fitting 10 is inserted into gripping member 136. Upon reading this specification, it should be appreciated that, under appropriate circumstances, considering such issues as user preferences, design preference, structural requirements, marketing preferences, cost, available materials, technological advances, etc., other structural arrangements such as, for example, additional handle structures and features, such as magnetic retention means or articulating handles, more or less contact points, etc., may be sufficient.

Those with ordinary skill in the art will now appreciate that upon reading this specification and by their understanding the art of maintaining greased mechanisms as described herein, methods of installing/engaging a grease-fitting will be understood by those knowledgeable in such art.

According to one embodiment, the hand-tool 100 may be arranged as a kit 105. In particular, the hand-tool 100 may further include a set of instructions 107. The instructions 107 may detail functional relationships in relation to the structure of the hand-tool 100 such that the hand-tool 100 can be used, maintained, or the like, in a preferred manner.

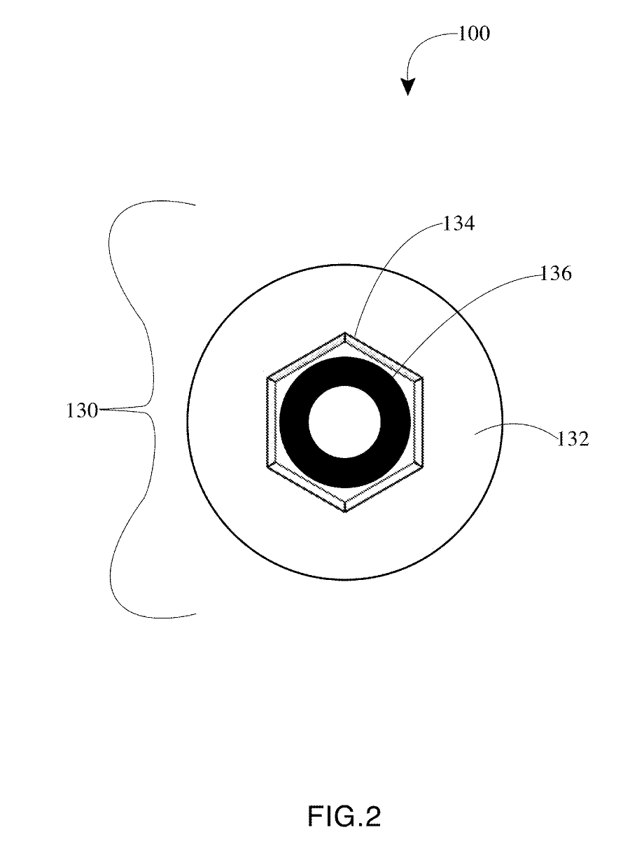

FIG. 2 shows hand-tool of FIG. 1, according to an embodiment of the present disclosure. As above, hand-tool 100 may include first-tool head 130, hollow-socket 132, six internal contact-surfaces 134, and gripping-member 136. Gripping member 136 may be removably attached to hollow-socket 132, gripping member 136 being retained within hollow-socket 132 by friction. Gripping member 136 may be composed of rubber, silicone, neoprene, or other deformable materials the tubular insert may be complemented or replaced by a magnetic insert capable of retaining a ferrous grease fitting in direct contact with the magnet.

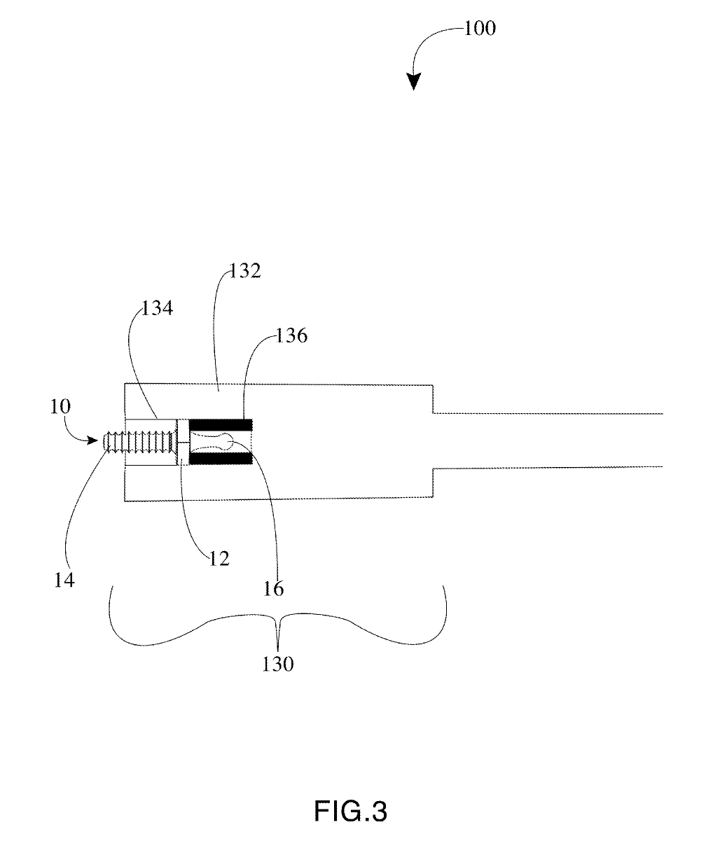

Referring now to FIG. 3, a cutaway view of first-tool head 130 of hand-tool 100 of FIG. 1, according to an embodiment of the present disclosure. As above, hand-tool 100 may include first-tool head 130, hollow-socket 132, six internal contact-surfaces 134, and gripping-member 136. In one embodiment, six internal contact-surfaces 134 of hollow-socket 132 measure within five percent of five-sixteenths of an inch in diameter across-flats, six internal contact-surfaces 134 being dimensioned to receive and engage grease-fitting 10 having hexagonal-collar 12 measuring approximately five-sixteenths of an inch in diameter across-flats. In an alternative embodiment, six internal contact-surfaces 134 of hollow-socket 132 may measure within five percent of seven-sixteenths of an inch in diameter across-flats, six internal contact-surfaces 134 being dimensioned to receive and engage grease-fitting 10 having hexagonal-collar 12 measuring approximately seven-sixteenths of an inch in diameter across-flats. Other embodiments may incorporate alternative dimensions for six internal contact-surfaces 134 of hollow-socket 132, especially dimensions suitable for use with commercially available sizes of grease-fitting 10.

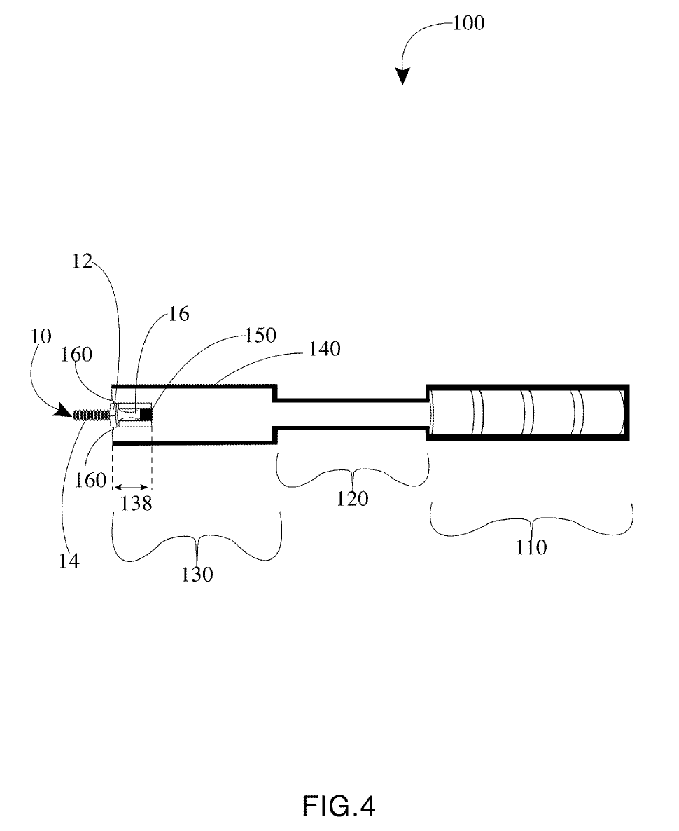

FIG. 4 is a cutaway view of hand-tool 100 of FIG. 1, according to an embodiment of the present disclosure. In one embodiment, hand-tool 100 may further include handle 110 and shaft 115 coupling handle 110 to hollow-socket 132. Additionally, hand-tool 100 may also include cover 140, cover 140 being permanently affixed to and enveloping handle 110. Cover 140 may also envelop shaft 115, hollow-socket 132, and first-tool head 130. Cover 140 may be able to improve comfort and retention characteristics of hand-tool 100, and may also improve corrosion-resistance and cleanability in some embodiments. Cover 140 may be constructed of rubber, silicone, neoprene, or other deformable materials. First-tool head 130 may also include magnet 150 disposed interior to hollow-socket 132, magnet 150 being able to contact grease-fitting 10, grease-fitting 10 being ferrous, when grease-fitting 10 is received within hollow-socket 132. Hollow-socket 132 may also include socket-length 138 axial to socket-aperture 133 (FIG. 1), hollow-socket-length 138 being dimensioned to cover nipple 16 and hexagonal-collar 12 of grease-fitting 10, such that threaded-shank 14 is exposed when grease-fitting 10 is received within hollow-socket 132. Additionally, hollow-socket 132 may still further include chamfer 160, such that chamfer 160 bounds socket-aperture 133 and enable easy insertion of grease-fitting 10 into hollow-socket 132. Handle 110, shaft 115, and first-tool head 130 may be constructed of ferrous steel, stainless steel, aluminum, or another strong material able to withstand enough torque to fasten and unfasten grease-fitting 10. In some embodiments, handle 110, shaft 115, and first-tool head 130 may be releasably affixed to each other. In other embodiments, handle 110, shaft 115, and first-tool head 130 may be integral to each other. Shaft 115 may be rigidly coupled to handle 110, and first-tool head 130 may be rigidly coupled to shaft 115.

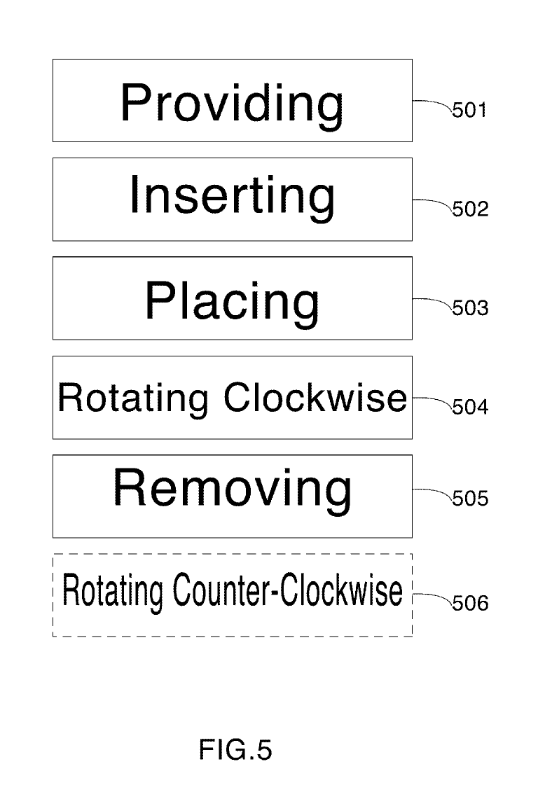

Referring now to FIG. 5 showing a flow diagram illustrating a method for installation of a grease-fitting 500, according to an embodiment of the present disclosure. In particular, the method for installation of a grease-fitting 500 may include one or more components or features of the hand-tool 100 as described above. As illustrated, the method for installing a grease-fitting 500 may include the steps of: step one 501, providing a hand-tool for installing a grease-fitting, the grease-fitting having a hexagonal-collar, a threaded-shank, and a nipple, the hand-tool comprising a first-tool head and a second-tool head, the first-tool head and the second-tool head each including a hollow-socket having a socket-aperture and six internal contact-surfaces hexagonally arranged, the six internal contact-surfaces being able to releasably engage the hexagonal-collar of the grease-fitting such that the grease-fitting may not rotate relative to the hollow-socket while in engagement with the six internal contact-surfaces, and a deformable, cylindrical gripping member disposed within the hollow-socket having an interior diameter, the interior diameter being smaller than an exterior diameter of the nipple of the grease-fitting, such that the gripping member deforms around the nipple of the grease-fitting when the grease-fitting is inserted into the gripping member, and a tool-head couple joining the first-tool head to the second-tool head, the tool-head couple having a couple-axis and a tool-interface configured to engage with a wrench; step two 502, inserting the grease-fitting into the hollow-socket, such that the hexagonal-collar of the grease fitting is in engagement with the six internal contact-surfaces of the hollow-socket; step three 503, placing the threaded-shank of the grease-fitting against a grease-fitting receptacle; step four 504, rotating the hand-tool clockwise to advance the threaded-shank of the grease-fitting within the grease-receptacle; step five 505, removing the hand-tool from the grease fitting; and step six 506, rotating the hand-tool counter-clockwise to withdraw the threaded-shank of the grease-fitting from within the grease-fitting receptacle.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods/means for installing a grease-fitting, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A hand-tool for installing a grease-fitting, the grease-fitting having a hexagonal-collar, a threaded-shank, and a nipple, the hand-tool comprising:
a first-tool head and a second-tool head, the first-tool head and the second-tool head each including
a hollow-socket having a socket-aperture and six internal contact-surfaces hexagonally arranged, the six internal contact-surfaces being able to releasably engage the hexagonal-collar of the grease-fitting such that the grease-fitting may not rotate relative to the hollow-socket while in engagement with the six internal contact-surfaces, and
a deformable, cylindrical gripping member disposed within the hollow-socket having an interior diameter, the interior diameter being smaller than an exterior diameter of the nipple of the grease-fitting, such that the gripping member deforms around the nipple of the grease-fitting when the grease-fitting is inserted into the gripping member; and
a tool-head couple joining the first-tool head to the second-tool head, the tool-head couple having a couple-axis and a tool-interface configured to engage with a wrench.

2. The hand-tool of claim 1, further comprising a handle structured and arranged to be grasped by a hand of a user.

3. The hand-tool of claim 2, further comprising a shaft rigidly coupling the handle to the tool-head.

4. The hand-tool of claim 1, wherein the tool-interface includes a pair of substantially flat faces able to be engaged by a wrench, the pair of substantially flat faces being diametrically opposed across the couple-axis.

5. The hand-tool of claim 1, wherein the tool-interface includes six consecutively positioned faces able to be engaged by a wrench, each of the six consecutively positioned faces being angled sixty degrees from an adjacent one of the six consecutively positioned faces to join circumferentially about the couple-axis, the six consecutively positioned faces being radially arrayed about the couple-axis.

6. The hand-tool of claim 1, wherein the first-tool head and the second-tool head are each positioned concentrically to the couple-axis, such that the first-tool head and alternatively the second-tool head may engage and turn the grease-fitting while rotating on the couple-axis.

7. The hand-tool of claim 3, further comprising a cover permanently affixed to and enveloping the handle.

8. The hand-tool of claim 6, wherein the cover envelops the shaft and the hollow-socket.

9. The hand-tool of claim 1, wherein the six internal contact-surfaces of the hollow-socket measure within five percent of five-sixteenths of an inch in diameter across-flats, the six internal contact-surfaces being dimensioned to receive and engage the grease-fitting having the hexagonal-collar measuring approximately five-sixteenths of an inch in diameter across-flats.

10. The hand-tool of claim 1, wherein the six internal contact-surfaces of the hollow-socket measure within five percent of seven-sixteenths of an inch in diameter across-flats, the six internal contact-surfaces being dimensioned to receive and engage the grease-fitting having the hexagonal-collar measuring approximately seven-sixteenths of an inch in diameter across-flats.

11. The hand-tool of claim 1, wherein the first-tool head and the second-tool head each further include a magnet disposed interior to the hollow-socket, the magnet being able to contact the grease-fitting, the grease-fitting being ferrous, when the grease-fitting is received within the hollow-socket.

12. The hand-tool of claim 1, wherein the hollow-socket further includes a socket-length axial to the socket-aperture, the socket-length being dimensioned to cover the nipple and the hexagonal-collar of the grease-fitting, such that the threaded-shank is exposed when the grease-fitting is received within the hollow-socket.

13. The hand-tool of claim 1, wherein the hollow-socket further includes a chamfer bounding the socket-aperture, the chamfer enabling easy insertion of the grease-fitting into the hollow-socket.

14. The hand-tool of claim 1, wherein the handle, the shaft, the first-tool head, and the second-tool head are constructed of ferrous steel.

15. The hand-tool of claim 1, wherein the handle, the shaft, the first-tool head and the second-tool head are constructed of stainless steel.

16. The hand-tool of claim 1, wherein the handle, the shaft, the first-tool head, and the second-tool head are constructed of aluminum.

17. A grease-fitting installation tool for installing a grease-fitting, the grease-fitting having a hexagonal-collar, a threaded-shank, and a nipple, the grease-fitting installation tool comprising:
a first-tool head and a second-tool head, the first-tool head and the second-tool head each including
a hollow-socket having a socket-aperture and six internal contact-surfaces hexagonally arranged, the six internal contact-surfaces being able to releasably engage the hexagonal-collar of the grease-fitting such that the grease-fitting may not rotate relative to the hollow-socket while in engagement with the six internal contact-surfaces, and
a deformable, cylindrical gripping member disposed within the hollow-socket having an interior diameter, the interior diameter being smaller than an exterior diameter of the nipple of the grease-fitting, such that the gripping member deforms around the nipple of the grease-fitting when the grease-fitting is inserted into the gripping member; and
a tool-head couple joining the first-tool head to the second-tool head, the tool-head couple having a couple-axis and a tool-interface configured to engage with a wrench;
wherein the gripping member is removably attached to the hollow-socket, the gripping member being retained within the hollow-socket by friction;
wherein the hollow-socket further includes a socket-length axial to the socket-aperture, the socket-length being dimensioned to cover the nipple and the hexagonal-collar of the grease-fitting, such that the threaded-shank is exposed when the grease-fitting is received within the hollow-socket; and
wherein the hollow-socket further includes a chamfer bounding the socket-aperture, the chamfer enabling easy insertion of the grease-fitting into the hollow-socket.

18. The hand-tool of claim 17, further comprising set of instructions; and
wherein the hand-tool is arranged as a kit.

19. A method of installing a grease-fitting, the method comprising the steps of:
providing a hand-tool for installing a grease-fitting, the grease-fitting having a hexagonal-collar, a threaded-shank, and a nipple, the hand-tool comprising a first-tool head and a second-tool head, the first-tool head and the second-tool head each including a hollow-socket having a socket-aperture and six internal contact-surfaces hexagonally arranged, the six internal contact-surfaces being able to releasably engage the hexagonal-collar of the grease-fitting such that the grease-fitting may not rotate relative to the hollow-socket while in engagement with the six internal contact-surfaces, and a deformable, cylindrical gripping member disposed within the hollow-socket having an interior diameter, the interior diameter being smaller than an exterior diameter of the nipple of the grease-fitting, such that the gripping member deforms around the nipple of the grease-fitting when the grease-fitting is inserted into the gripping member, and a tool-head couple joining the first-tool head to the second-tool head, the tool-head couple having a couple-axis and a tool-interface configured to engage with a wrench;
inserting the grease-fitting into the hollow-socket, such that the hexagonal-collar of the grease fitting is in engagement with the six internal contact-surfaces of the hollow-socket;
placing the threaded-shank of the grease-fitting against a grease-fitting receptacle;
rotating the hand-tool clockwise to advance the threaded-shank of the grease-fitting within the grease-receptacle; and
removing the hand-tool from the grease fitting.

20. The method of claim 19, further comprising the steps of
rotating the hand-tool counter-clockwise to withdraw the threaded-shank of the grease-fitting from within the grease-fitting receptacle.
